(19) United States
(12) Patent Application Publication
(10) Pub. No.: US 2009/0056748 A1
(43) Pub. Date: Mar. 5, 2009

(54) Grill Brush

(76) Inventor: Michael Wales, Riverside, CT (US)

Correspondence Address: ST. ONGE STEWARD JOHNSTON & REENS, LLC, 986 BEDFORD STREET, STAMFORD, CT, 06905-5619, US

(21) Appl. No.: 12/179,344

(22) Filed: Jul. 24, 2008

Related U.S. Application Data
(60) Provisional application No. 60/951,528, filed on Jul. 24, 2007.

(51) Int. Cl. A46B 11/04; B08B 1/00

(52) U.S. Cl. 134/6; 15/104.94

(57) ABSTRACT

A grill brush including a body having an internal liquid reservoir for containing a fluid, a brush head having at least one hole in fluid communication with the internal reservoir for providing a fluid to the grill surface, and a handle is provided. A plurality of bristles extends from the brush head. A scraper brush having a plurality of stiff bristles is provided. Additionally, a flow control unit controls the flow of a fluid from the internal reservoir to the at least one hole.

### CROSS-REFERENCE TO RELATED APPLICATIONS

This application claims priority benefits under 35 § U.S.C. 119(e) of the U.S. Provisional Application No. 60/951,528 filed on Jul. 24, 2007.

### FIELD OF THE INVENTION

The present invention relates to grill brushes and more particularly relates to a new grill brush for cleaning the grates of a grill while also applying a cleaning fluid.

### BACKGROUND OF THE INVENTION

The present invention pertains to grill brushes for cleaning grill grates such as the grates of gas fired barbecue grills, and charcoal fired barbecue grills.

The use of brushes and scrapers for the cleaning of grill grates of grills is well known. Typically, grill brushes have a handle portion and a head portion, having metallic bristles, which are generally all of a constant length and form a generally planar abrasive surface. This bristle configuration permits the top surface of the grill to be scrubbed with the grill brush, but does not facilitate the cleaning of the sides of the grill grate bars. With known grill brushes, it is therefore difficult to remove accumulated deposits from the sides of the grate bars without significant effort.

Without proper cleaning, grease and food residue can build up on the grates of the grill. This buildup can lead to corrosion of the grates and does not provide a sanitary surface for food preparation.

It is therefore desirable to have a grill brush that effectively removes deposits and grease from the sides of the grill grate bars while also removing deposits from the top surface of the grate. In addition, it is desirable to have a grill brush that can be used to clean the inside and outside of a grill and remove deposits from hard to reach crevices.

### SUMMARY OF THE INVENTION

Accordingly, it is an object of the present invention to provide a grill brush with bristles and a scraper for cleaning both the top and side surfaces of grill grates.

It is a further object of the invention to provide a grill brush with a means for dispensing a liquid solvent in a controlled manner to a position closely adjacent to the brush bristles as they are scrubbing a surface.

It is a further object of the invention to provide a grill brush with a scraper portion having at least one row of stiff bristles for loosening food debris by causing the bars of a grill grate to vibrate when the scraper is moved perpendicular to the direction of the bars.

These and other objects and advantages are achieved by providing a grill brush comprising a body portion having an internal reservoir, a main handle formed as part of said body portion, a brush head having at least one hole extending therethrough, said hole being in fluid communication with said reservoir, a plurality of bristles extending from said brush head, and a flow control device for controlling fluid flow between said reservoir and said at least one hole. In an embodiment, the brush head defines a first axis, the main handle defines a second axis, and the first axis intersects said second axis at an angle α, which may be an acute angle. More specifically, α may be 40 degrees.

The grill brush may also comprising a scraper brush having a plurality of bristles. The bristles of said scraper brush may have a stiffness sₛ, the bristles of said brush head may have a stiffness s_{b}, and sₛ may be greater than s_{b}. In addition, the bristles of said scraper brush may have a diameter dₛ, the bristles of said brush head may have a diameter d_{b}, and dₛ may be greater than d_{b}. The bristles of said scraper brush may be arranged in a plurality of bundles, said bundles being arranged a single row. The scraper brush may be oriented at a generally obtuse angle with respect to said brush head.

In a further embodiment, the flow control device may comprise a flow restrictor for regulating the rate of fluid flow from said reservoir to said at least one hole. The flow restrictor may further comprise a conduit in fluid communication with said internal reservoir and said at least one hole, the conduit in one embodiment having a generally elliptical-shaped opening at an end closest said at least one hole. In yet a further embodiment, the brush head may further comprise a second reservoir in fluid communication with said at least one hole and said opening. The opening may be situated approximately over the center of the second reservoir. The conduit may be oriented at a generally acute angle with respect to said brush head.

The flow control device may also comprise a shut off valve for regulating fluid communication between said reservoir and said at least one hole. The shut of valve may have an open position which allows fluid communication between said reservoir and said at least one hole and a closed position which prevents fluid communication between said reservoir and said at least one hole.

In another embodiment, the grill brush may comprise an intake valve having a generally conical shaped body, said intake valve having one end in fluid communication with the ambient environment and one end in fluid communication with the internal reservoir. The intake valve may further comprise a slit-shaped opening on said end in fluid communication with the internal reservoir. The intake valve may be situated within a cap which seals the internal reservoir.

Also provided is a method for cleaning the surface of a grill comprising the steps of providing a grill brush comprising: a body portion having an internal reservoir, a brush head having at least one hole extending therethrough, said hole being in fluid communication with said reservoir, and a plurality of bristles extending from said brush head; heating said grill; filling said internal reservoir with a fluid; and bringing said plurality of bristles into moving contact with the surface of the grill while the fluid is dispensed through the at least one hole.

The provided grill brush may further comprise a scraper brush having a plurality of bristles extending therefrom. The scraper brush may be oriented at a generally obtuse angle with respect to said brush head. The bristles of said scraper brush may have a stiffness sₛ, the bristles of said brush head may have a stiffness s_{b}, and sₛ may be greater than s_{b}. In addition, the bristles of said scraper brush may have a diameter dₛ, the bristles of said brush head may have a diameter d_{b}, and dₛ may be greater than d_{b}. The plurality of bristles of said scraper brush may be arranged in a plurality of bundles, said bundles being arranged a single row. The grill surface may comprise a plurality of parallel grill grates and the method may further comprise the step of bringing said scraper brush in moving contact with the grill surface perpendicular to the plurality of grill grates.

Last, method for cleaning the surface of a grill comprising the steps of providing a grill brush comprising: a body portion having an internal reservoir, a brush head having at least one hole extending therethrough, said hole being in fluid communication with said reservoir, a plurality of bristles extending from said brush head, and a flow control device for controlling fluid flow between said reservoir and said at least one hole; heating said grill; filling said internal reservoir with a fluid; and bringing said plurality of bristles into moving contact with the surface of the grill while the fluid is dispensed through the at least one hole is also provided.

In an embodiment, the flow control device may comprise a flow restrictor for regulating the rate of fluid flow from said reservoir to said at least one hole. The flow restrictor may comprise a conduit in fluid communication with said internal reservoir and said at least one hole. The conduit may have a generally elliptical-shaped opening at an end closest said at least one hole. Further, the brush head may comprise a second reservoir in fluid communication with said at least one hole and said opening. The opening may be situated approximately over the center of the second reservoir. In one embodiment, the conduit is oriented at a generally acute angle with respect to said brush head.

In another embodiment, the flow control device may comprise a shut off valve for regulating fluid communication between said reservoir and said at least one hole. The shut off valve may have an open position which allows fluid communication between said reservoir and said at least one hole and a closed position which prevents fluid communication between said reservoir and said at least one hole. The method may further comprise the step of placing said shut off valve in the open position.

In yet another embodiment, the grill brush further comprises an intake valve having one end in fluid communication with the ambient environment and one end in fluid communication with the internal reservoir. The intake valve may further comprise a slit-shaped opening on said end in fluid communication with the internal reservoir.

Other objects, features and advantages according to the present invention will become apparent from the following detailed description of several embodiments of the invention as described in conjunction with the drawings.

### BRIEF DESCRIPTION OF THE DRAWINGS

FIG. 1 is a sectional side view of one embodiment of the disclosed grill brush.

FIG. 2 is an exploded view of one embodiment of the disclosed grill brush.

FIG. 3a is a bottom view of a reservoir cap for use with the disclosed grill brush.

FIG. 3b is a perspective view of a reservoir cap for use with the disclosed grill brush.

FIG. 4a is a perspective view of the bottom of a mounting plate for use with the disclosed grill brush.

FIG. 4b is a view of the top of a mounting plate for use with the disclosed grill brush.

FIG. 5a is a top view of a brush head for use with the disclosed grill brush.

FIG. 5b is a bottom view of a brush head for use with the disclosed grill brush.

FIG. 5c is a perspective view of a brush head for use with the disclosed grill brush.

FIG. 5d is a side view of a brush head for use with the disclosed grill brush showing the placement of the at least one hole.

FIG. 5e is a side view of a brush head for use with the disclosed grill brush showing the placement of the plurality of bristle bundles.

FIG. 6a is a top view of an intake valve for use with the disclosed grill brush.

FIG. 6b is a perspective view of an intake valve for use with the disclosed grill brush.

FIG. 6c is a side view of an intake valve for use with the disclosed grill brush.

FIG. 6d is a side view of an intake valve for use with the disclosed grill brush.

FIG. 7a is a side view of a shut-off valve for use with the disclosed grill brush.

FIG. 7b is a side view of a shut-off valve for use with the disclosed grill brush.

FIG. 7c is a perspective view of a shut-off valve for use with the disclosed grill brush.

FIG. 8a is a top view of a flow restrictor for use with the disclosed grill brush.

FIG. 8b is a bottom view of a flow restrictor for use with the disclosed grill brush.

FIG. 8c is a side view of a flow restrictor for use with the disclosed grill brush.

FIG. 8d is a perspective view of a flow restrictor for use with the disclosed grill brush.

FIG. 9a is a side sectional view of a gasket for use with the disclosed grill brush.

FIG. 9b is a perspective view of a gasket for use with the disclosed grill brush.

FIG. 9c is a bottom view of a gasket for use with the disclosed grill brush.

FIG. 10 is a sectional side view of one embodiment of the disclosed grill brush.

FIG. 11 is an exploded view of one embodiment of the disclosed grill brush.

FIG. 12a is a bottom view of a reservoir cap for use with the disclosed grill brush.

FIG. 12b is a perspective view of a reservoir cap for use with the disclosed grill brush.

FIG. 13a is a top view of a brush head for use with the disclosed grill brush.

FIG. 13b is a bottom view of a brush head for use with the disclosed grill brush.

FIG. 13c is a perspective view of a brush head for use with the disclosed grill brush.

FIG. 13d is a side view of a brush head for use with the disclosed grill brush showing the placement of the at least one hole.

FIG. 13e is a side view of a brush head for use with the disclosed grill brush showing the placement of the plurality of bristle bundles.

### DETAILED DESCRIPTION OF THE INVENTION

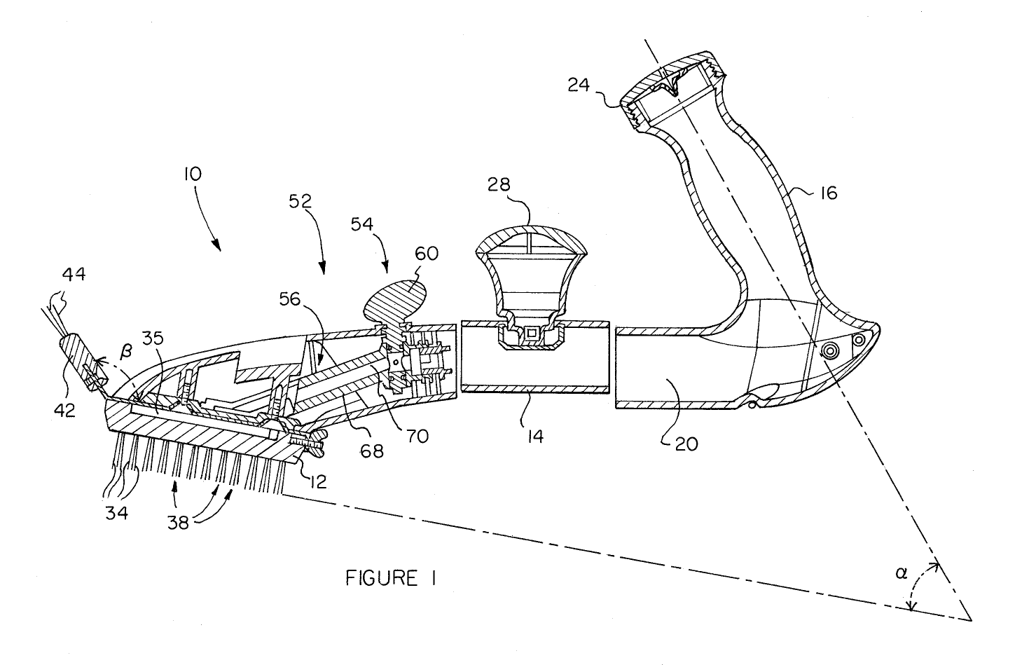

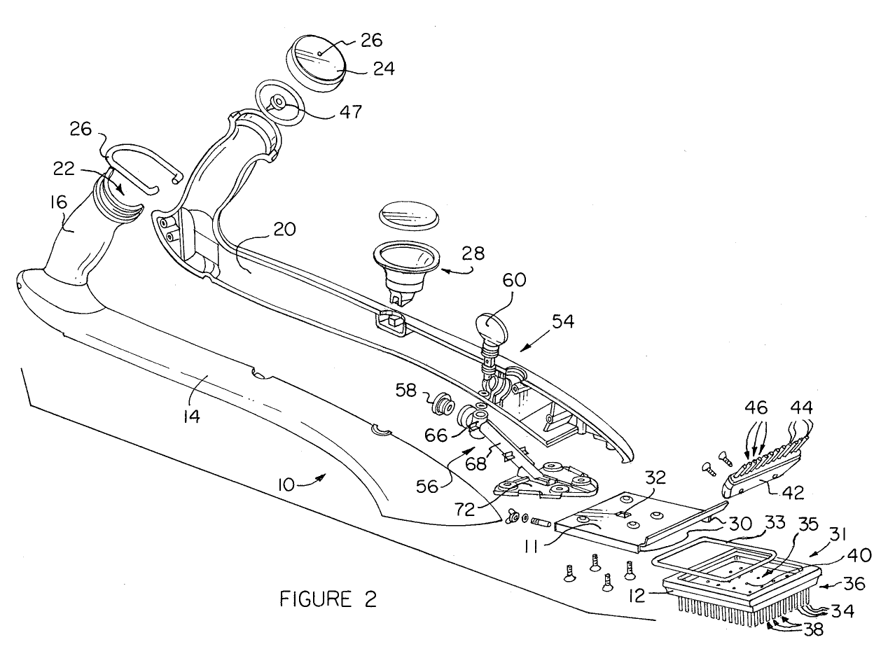

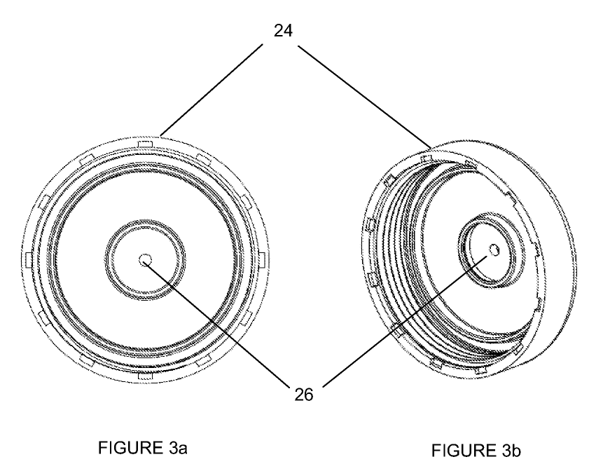

With reference to FIGS. 1 and 2, one embodiment of the disclosed grill brush 10 is shown. The grill brush 10 comprises a mounting plate 11, brush head 12, and a body 14 which terminates in a bush handle 16. The brush handle 16 extends away from the body 14, preferably from the surface opposite the brush head 12, and is designed for a user to grasp when using the grill brush 10. Brush handle 16 may also be contoured as shown for added grip. Reservoir 20 runs through the body 14 and into the brush handle 16. A user may fill the reservoir 20 with a fluid, such as water or cleaning solvent, through the opening 22 at the end of the brush handle 16. Reservoir cap 24 is located on the end of brush handle 16 to close off the reservoir (FIGS. 3a, 3b). Hook 26 is affixed to the end of the body 14 below the brush handle 16 for easy storage of the brush.

Brush handle 16 is oriented at an angle α with respect to the grill surface. Preferably, α is 40 degrees when the grill brush is in use and the brush head 12 is held parallel to the grill surface. This allows the user to grip the handle with a fist type grip similar to that of a joystick, and to hold his or her wrist in optimal ergonomic position. As compared to other prior art brushes which are held with the palm of the hand on the body of the brush with pressure exerted downward between the thumb and forefinger, the orientation of brush handle 16 allows for greater leverage against the surface to be cleaned. Table 1 below compares the maximum force generated by grill brush 10 of the present invention with other known prior art grill brushes. Maximum force is the amount of force a 200 lb man can exert on the brush portion and hold for a one minute duration, holding the brush by its appropriate handles.

TABLE 1
Comparison of prior art brushes with grill brush 10.

| | Char-Broil ® | | Mr. Bar-B-Q ® | |
|---|---|---|---|---|
| | Brush Hawg | Perfect Flame ® | Stainless Steel | |
| | Heavy-Duty Grill | Grill Brush | Grill Brush | |
| | Brush (Model | (Model No. | (Model No. | |
| | No. 4984106) | 15223) | B00006C7GV) | Grill Brush 10 |
| Overall Length (in.) | 16.5 | 18 | 18 | 22 |
| Main Bristle Pad (in.²) | 6.5 | 4 | 9 | 9.75 |
| Number of bristle bundles | 95 | 70 | 132 | 132 |
| Bristles per bundle | 30 | 56 | 40 | 42 |
| Bristle length (in.) | 0.75 | 0.625 | 0.625 | 0.625 |
| Bristle diameter | 0.007 | 0.0065 | 0.0065 | 0.008 |
| Total bristles per brush | 2850 | 3920 | 5280 | 5544 |
| Maximum downward force (lbs.) | 18.2 | 13 | 16 | 36.3 |
| Maximum lateral force (lbs.) | 30 | 18 | 29 | 56 |

An auxiliary handle 28 is also provided along the body 14 for a user to grasp, in addition to the brush handle 16, when using the grill brush 10. This auxiliary handle gives the user additional leverage against the surface being cleaned. Preferably, the auxiliary handle 28 is situated about midway along the length of the body 14 and extends from the top surface. However, the auxiliary handle 28 may be located in many positions, including along the side of the body 14. As shown in FIG. 1, auxiliary handle 28 is shaped as a knob, but other shapes are contemplated.

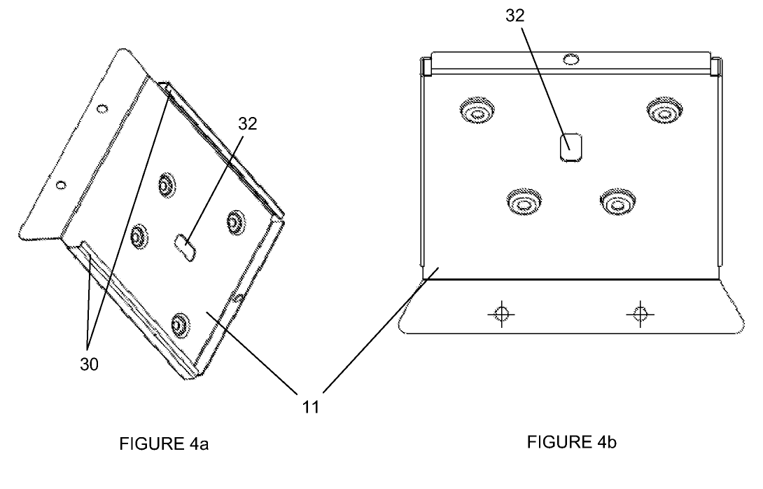

A mounting plate 11 (FIGS. 4a, 4b), comprising brackets 30 and through hole 32, is located at the end of the body 14 opposite of the brush handle 16. A brush head 12 releasably slides into brackets 30 on the mounting plate 11. On the inner side 31 of the brush head 12, an o-ring 33 is provided to ensure a water-tight seal with the mounting plate 11. On the underside 36 of the brush head 12 are a plurality of brush bristles 34, grouped in a plurality of bundles 38. In a preferred embodiment, 132 bundles containing forty-two (42) individual bristles are arranged in a grid pattern on the underside 36 of the brush head 12. However, different numbers and arrangements of bristles 34 and bundles 38 are contemplated. The bristles 34 can be made of any material that is non-corrosive and durable, yet gentle enough to not damage the surface of the grill grates, such as brass or stainless steel. The bristles 34 are preferably 0.008 inches in diameter. The entire brush head 12 may be removed from the brackets 30 for cleaning or replacement.

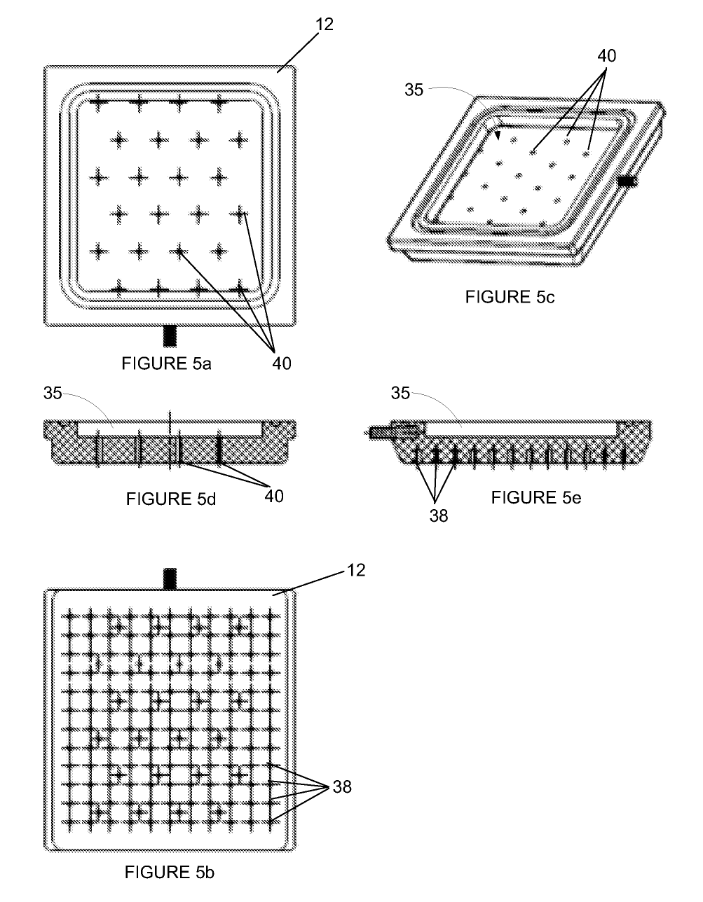

A plurality of holes 40 are also located on the underside 36 of the brush head 12 for releasing fluid onto the surface to be cleaned. The holes 40 are in fluid communication with the reservoir 20. Preferably, the holes 40 are arranged in an alternating grid pattern with the bristle bundles 38. FIGS. 5a and 5b show one possible arrangement of holes 40 and bristle bundles 38. The size of the holes 40 is such that they are large enough to allow for the free flow of fluid while not allowing the fluid to evacuate the reservoir 20 through only one or two of the holes 40. In addition, the size of the holes 40 is such that a certain size droplet is produced which will not evaporate immediately on contacting a hot grill grate but, is substantial enough to soak into and saturate the baked on food residue and grease prior to evaporation. In operation, the heat remaining on the grill grates causes the fluid to expand and turn to vapor, thus loosening the food residue by the by the force of the escaping vapor. The brushing action of the brush 10 moves away the broken up baked on particles that have been loosened by the heating of the water and the force of the escaping steam.

A second reservoir 35 (FIGS. 5c,5d,5e) on the inner side 31 of the brush head 12 collects fluid supplied from the reservoir 20. The depth of the second reservoir is such that when the fluid collects in the second reservoir, it is distributed over all of holes 40 so that fluid is evenly dispensed at a steady flow onto the cleaning surface. Preferably, the second reservoir is 2⅞ in×2¾ in with a depth of 0.24 in. The volume of the second reservoir is such that it also provides enough pressure to force fluid through the holes 40. Preferably, it holds 30 ml of fluid.

A scraper brush 42 is attached to the mounting plate 11 at an angle β with respect to the brush head 12. Preferably β is an obtuse angle. The scraper brush 42 has plurality of stiff bristles 44, grouped into a plurality of bundles 46. The stiff bristles 44 have a greater stiffness than the bristles 40 of the brush head 12. This may be achieved in any number of ways, including by using bristles of a higher gauge or by using a stiffer material. Preferably, the scraper brush 42 is provided with 13 bristle bundles each having 18 extra-stiff bristles, for a total of 234 bristles. Preferably, the bristles are 0.016 inches in diameter. The scraper brush 42 maximizes the force against the grill surface by utilizing a single row of extra-stiff bristle bundles. To be sure, when a maximum downward force of 38.6 lb is applied to a flat surface, the bristles of the scraper brush 42 produce 820.45 lb/in² of total force. With the main brush head 12, when a maximum downward force of 36.3 is applied to a flat surface, the bristles of the brush head 12 produce 130.43 lb/in² of total force. Maximum force is the amount of force a 200 lb man can exert on the brush portion and hold for a one minute duration, holding the brush 10 by its appropriate handles.

To use the scraper brush 42, a user turns the brush 10 over and places the extra-stiff bristles 44 against the grill grates. Preferably, the user will move the scraper brush 42 from side to side, perpendicular to the grill grates. Because the scraper brush 42 can generate such an intense force, when brushed perpendicular to the grill grates as opposed to along the grill grates, the extra stiff bristles 44 will cause the grill grates to vibrate. As each bundle 46 of stiff bristles consecutively comes in contact with the grill grate, the vibration intensifies and may continue even after the brushing motion ceases. This vibration or harmonic action causes the burned on grease and food residue to expand beyond the original dimension of the grate and then dislodge by the abrasive action of the scraper brush bristles 44 pushing against the loosened food residue. This harmonic vibration is unexpected and leads to unexpected improved cleaning of the grill grates by the grill brush 10 with extra stiff bristles 44.

An intake hole 30 is provided on the surface of the reservoir cap 24 (FIG. 3). When water leaves reservoir 20 through holes 40, negative pressure is created and air is drawn into the reservoir 20 through intake hole 26. This intake hole 26 is necessary for the brush 10 to function properly because it restores air pressure within the reservoir allowing for a continuous flow of water through holes 40.

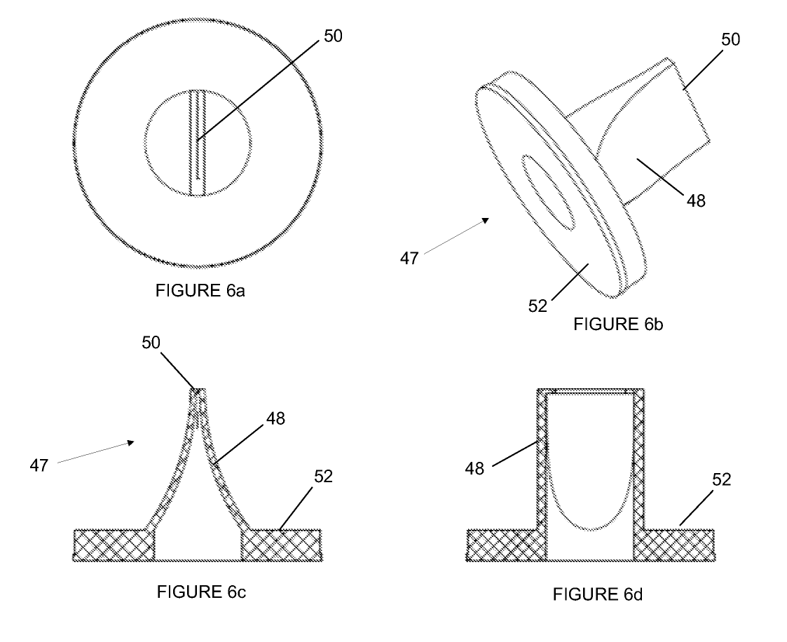

Pressed into reservoir cap 24 is an intake valve 47 which regulates air flowing into the reservoir 20 through intake hole 26. As shown in FIGS. 6a-6d, intake valve 47 has a conical body 48, a slit-shaped opening 50 at the bottom, and a rim 52 which fits into the cap 24. When the pressure inside the reservoir 20 is less than ambient pressure, intake valve 47 allows air to flow into the reservoir from intake hole 26 through the slit-shaped opening 50. In addition, intake valve 47 prevents water from escaping the reservoir 20 through intake hole 26. When the intake valve 47 is surrounded by water, as is the case if the grill brush were inverted, the pressure exerted on the conical body 48 prevents the slit 50 from opening, thus preventing water from escaping through intake hole 26.

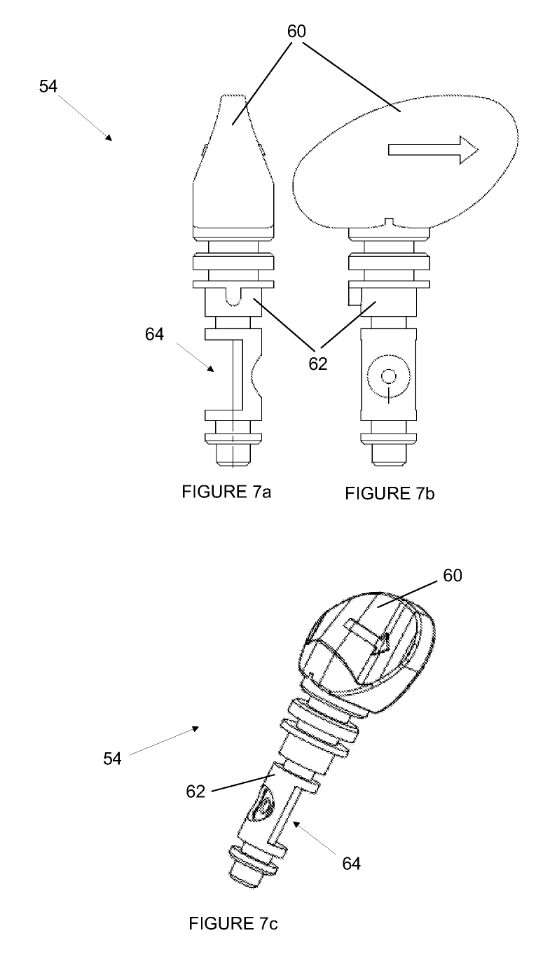

A flow control unit 52 controls the flow of fluid from the reservoir 18 to the brush head 12. The flow control unit comprises a shut-off valve 54 (FIGS. 7a-7c), flow restrictor 56, and gasket 58. Shut-off valve 54 comprises a grip 60, an elongated body 62 and an inlet channel 64. In an open position (FIG. 7a), fluid flows from the reservoir 20 and through the inlet channel 64 to allow fluid communication between the reservoir 20 and the plurality of holes 40. In a closed position (FIG. 7b), fluid from the reservoir is blocked by the elongated body 62 of the shut-off valve 54, thus preventing fluid communication between the reservoir 20 and the plurality of holes 40. There is also a continuum of positions between “on” and “off” in which shut-off valve 54 may be positioned to fine tune the level of fluid communication between reservoir 20 and the plurality of holes 40.

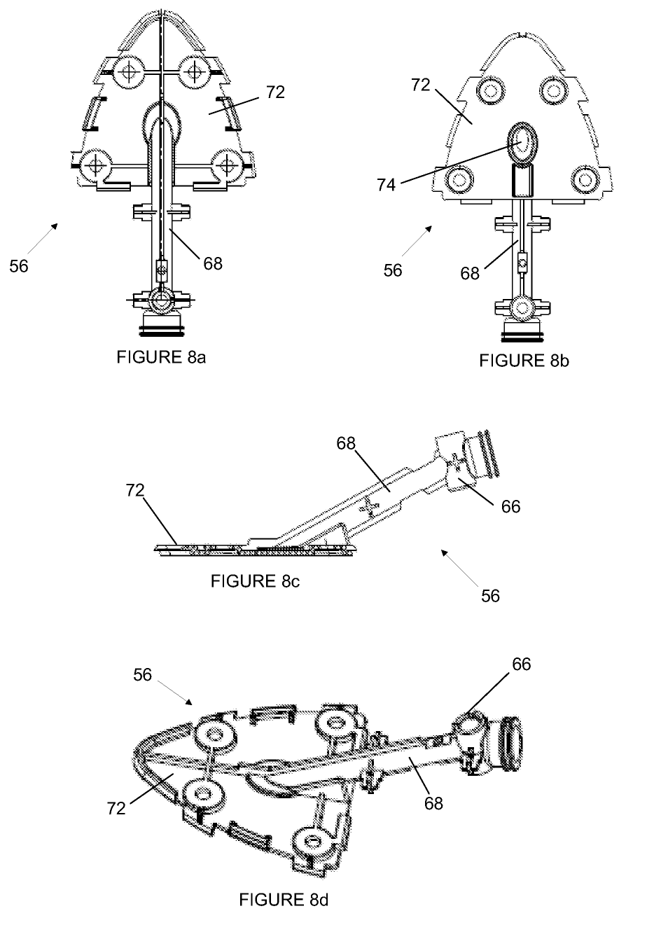

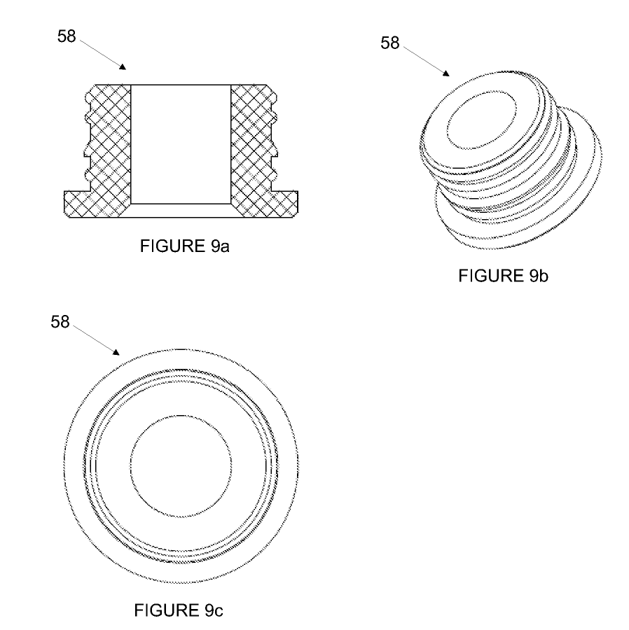

As shown in FIGS. 8a-8d, flow restrictor 56 comprises a shoulder 66, a stem 68 having an internal conduit 70 in fluid communication with both the reservoir 20 and the plurality of holes 40, and a base 72 which is affixed to mounting plate 11. Outlet 74 of the internal conduit 70 aligns with inlet hole 32 of the mounting plate. Gasket 58 (FIGS. 9a-9c) fits into the opposite end of the internal conduit 70 and accepts fluid from the internal reservoir 20. Because the flow restrictor 56 is sealed within the reservoir 20, water may only pass through gasket 58 to reach the holes 40. Shut-off valve 54 fits sealingly into shoulder 66 to complete the flow control unit 52.

One purpose of the flow restrictor 56 is to prevent fluid from exiting the reservoir through the holes 40 at an uncontrolled rate. This is achieved in two respects. First, by forcing the fluid to travel through the narrow internal conduit 70, the rate at which the fluid passes from the reservoir to the holes may be controlled. Second, as can be seen from FIG. 1, flow restrictor 56 is positioned at an angle with respect to the brush head 12. This angle ensures a steady flow of fluid from the reservoir 20 to the holes 40 even if the brush head 12 is held flat against the grill surface.

In addition, flow restrictor 56 prevents fluid from exiting through only a subset of the holes 40. Internal conduit 70 terminates at the base 72 on an angle, giving outlet 74 an elliptical or oval shape. Because of this shape and the angled orientation of the stem 68, fluid enters the second reservoir 35 of the brush head 12 on an angle. This ensures that fluid is not only bearing upon one or two of the holes 40, but that it is dispersed over all of the holes 40, thus providing an even distribution of fluid onto the grill surface. Furthermore, because outlet 74 is situated closer to the center of the second reservoir 35, rather than near an edge, water from the reservoir will be evenly dispersed through all of the holes 40.

By adjusting the angle at which one uses the grill brush 10, the user can also maximize the flow of fluid through the at least one hole 40. Table 2 demonstrates how raising the bush handle affects the volume of fluid dispensed from the holes 40 over time. In the first position, all of the bristles of the main brush head 12 are resting on the grill surface. Thus, in this position there is maximum cleaning capability because all of the bristles are engaging the grill surface. As can be calculated from this data, the rate at which fluid is dispensed in the first position is linear—approximately 3.67 ml/sec. Thus, water is dispensed at a steady rate over the entire 90 second cleaning period, leaving some water remaining in the reservoir to continue cleaning. Optimal handle leverage is also achieved in this position, as is adequate heat protection for hands during cleaning.

TABLE 2
Volume of fluid dispensed versus brush head position.

| | Volume | Volume | Volume |
|---|---|---|---|
| | dispensed at | dispensed at | dispensed at |
| Brush Head | 30 seconds | 60 seconds | 90 seconds |
| Position | (ml) | (ml) | (ml) |
| Parallel to surface | 110 | 220 | 330 |
| to be cleaned | | | |
| Head tilted at a 15 | 140 | 270 | 380 |
| degree angle | | | |
| Head tilted at a 30 | 160 | 300 | 410 |
| degree angle | | | |

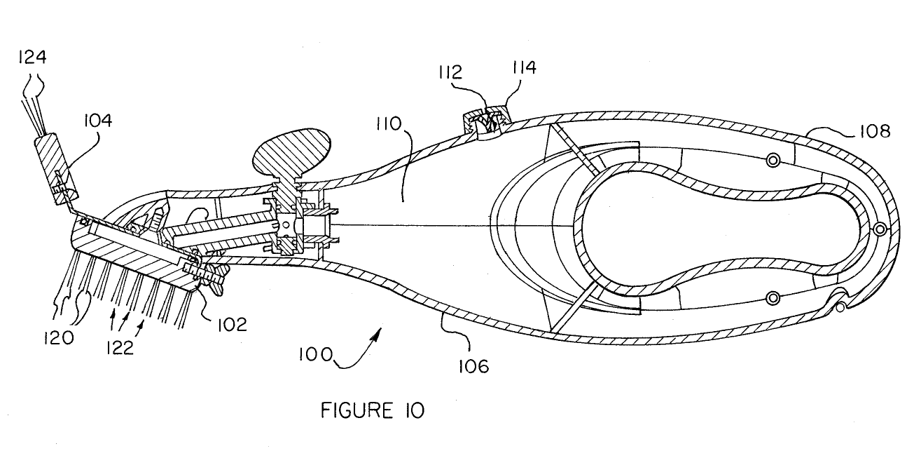

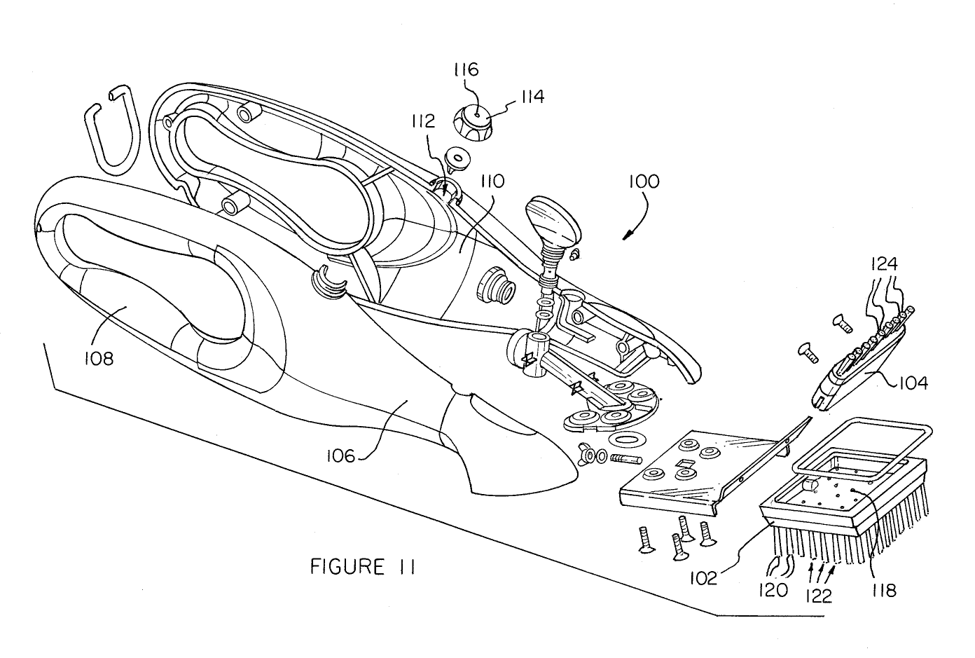

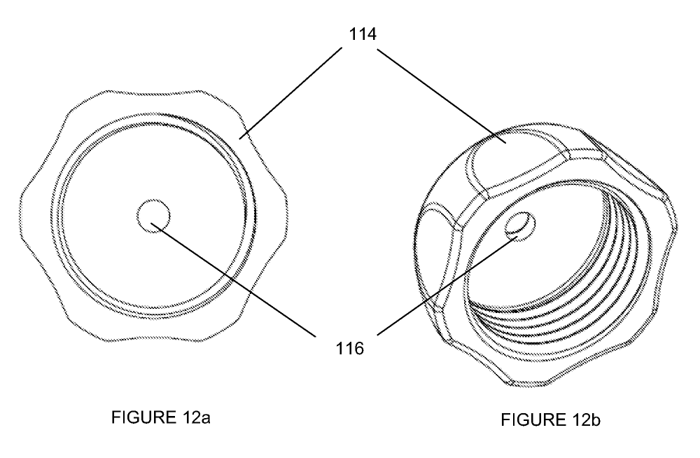

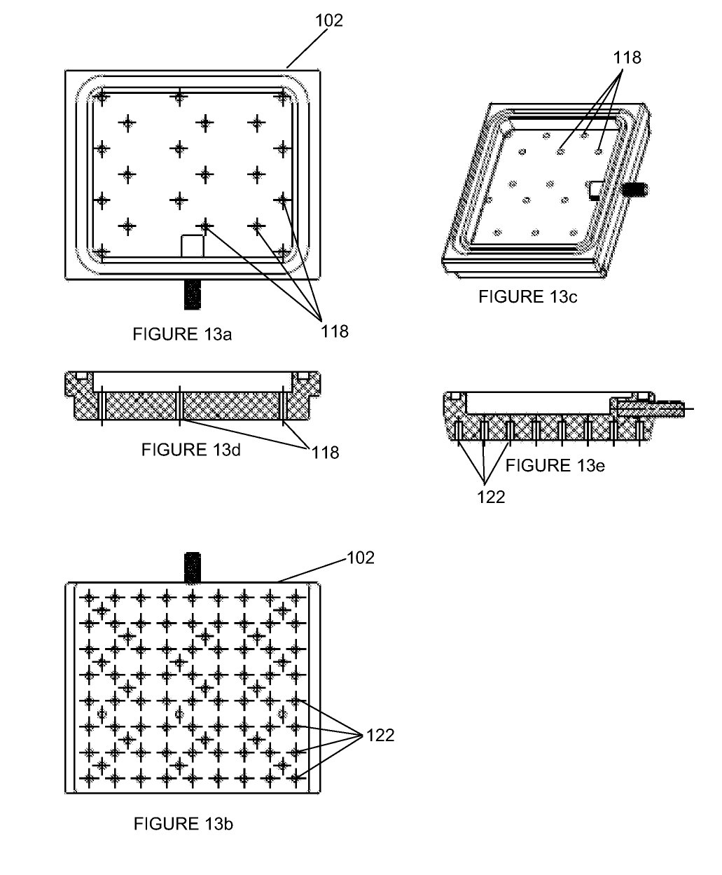

FIGS. 10 and 11 show an alternative embodiment of the grill brush 100, comprising a brush head 102, scraper brush 104, and a body 106 which terminates in a bush handle 108. In this embodiment, brush handle 108 takes the form of a hand grip. Internal reservoir 110 extends through the body 106 and can be filled with a fluid through opening 112. Reservoir cap 114 (FIGS. 12a,12b) with intake hole 116 seals off the internal reservoir 110. At least one hole 118 in fluid communication with reservoir 110 passes through brush head 102. Extending from the brush head 102 are a plurality of bristles 120 arranged in a plurality of bundles 122. FIGS. 13a-13e show one pattern for the plurality of bristle bundles 122 and the at least one hole 118. A plurality of stiff bristles 124 extend from scraper brush 104. The remaining elements of this alternative embodiment are substantially similar to the elements described above.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

1. A grill brush comprising:
a body portion having an internal reservoir;
a main handle formed as part of said body portion;
a brush head having at least one hole extending therethrough, said hole being in fluid communication with said reservoir;
a plurality of bristles extending from said brush head; and
a flow control device for controlling fluid flow between said reservoir and said at least one hole.

2. The grill brush of claim 1 wherein said brush head defines a first axis, wherein said main handle defines a second axis, and wherein said first axis intersects said second axis at an angle α.

3. The grill brush of claim 2 wherein said angle α is an acute angle.

4. The grill brush of claim 3 wherein said angle α is 40 degrees.

5. The grill brush of claim 1 further comprising a scraper brush having a plurality of bristles.

6. The grill brush of claim 5 wherein said scraper brush is oriented at a generally obtuse angle with respect to said brush head.

7. The grill brush of claim 5 wherein said bristles of said scraper brush have a stiffness sₛ, wherein said bristles of said brush head have a stiffness s_{b}, and wherein sₛ>s_{b}.

8. The grill brush of claim 5 wherein said bristles of said scraper brush have a diameter dₛ, wherein said bristles of said brush head have a diameter d_{b}, and wherein dₛ>d_{b}.

9. The grill brush of claim 5 wherein said plurality of bristles of said scraper brush are arranged in a plurality of bundles, said bundles being arranged a single row.

10. The grill brush of claim 1 wherein said flow control device comprises a flow restrictor for regulating the rate of fluid flow from said reservoir to said at least one hole.

11. The grill brush of claim 10 wherein said flow restrictor comprises a conduit in fluid communication with said internal reservoir and said at least one hole.

12. The grill brush of claim 11 wherein said conduit has a generally elliptical-shaped opening at an end closest said at least one hole.

13. The grill brush of claim 12 wherein said brush head further comprises a second reservoir in fluid communication with said at least one hole and said opening.

14. The grill brush of claim 13 wherein said opening is situated approximately over the center of the second reservoir.

15. The grill brush of claim 11 wherein said conduit is oriented at a generally acute angle with respect to said brush head.

16. The grill brush of claim 1 wherein said flow control device comprises a shut off valve for regulating fluid communication between said reservoir and said at least one hole.

17. The grill brush of claim 16 wherein said shut of valve has an open position which allows fluid communication between said reservoir and said at least one hole and a closed position which prevents fluid communication between said reservoir and said at least one hole.

18. The grill brush of claim 1 further comprising an intake valve having a generally conical shaped body, said intake valve having one end in fluid communication with the ambient environment and one end in fluid communication with the internal reservoir.

19. The grill brush of claim 18 wherein said intake valve further comprises a slit-shaped opening on said end in fluid communication with the internal reservoir.

20. The grill brush of claim 18 further comprising a cap for sealing said internal reservoir, said intake valve being situated within said cap.

21. A method for cleaning the surface of a grill comprising:
providing a grill brush comprising:
a body portion having an internal reservoir;
a brush head having at least one hole extending therethrough, said hole being in fluid communication with said reservoir; and
a plurality of bristles extending from said brush head;
heating said grill;
filling said internal reservoir with a fluid; and
bringing said plurality of bristles into moving contact with the surface of the grill while the fluid is dispensed through the at least one hole.

22-39. (canceled)

40. The method of claim 21 wherein said grill brush further comprises a scraper brush having a plurality of bristles extending therefrom.

41. The method of claim 40 wherein said scraper brush is oriented at a generally obtuse angle with respect to said brush head.

42. The method of claim 40 wherein said bristles of said scraper brush have a stiffness sₛ, wherein said bristles of said brush head have a stiffness s_{b}, and wherein sₛ>s_{b}.

43. The method of claim 40 wherein said bristles of said scraper brush have a diameter dₛ, wherein said bristles of said brush head have a diameter d_{b}, and wherein dₛ>d_{b}.

44. The method of claim 40 wherein said plurality of bristles of said scraper brush is arranged in a plurality of bundles, said bundles being arranged a single row.

45. The method of claim 40 wherein said grill surface comprises a plurality of parallel grill grates and further comprising the step of bringing said scraper brush in moving contact with the grill surface perpendicular to the plurality of grill grates.

46. A method for cleaning the surface of a grill comprising:
providing a grill brush comprising:
a body portion having an internal reservoir;
a brush head having at least one hole extending therethrough, said hole being in fluid communication with said reservoir;
a plurality of bristles extending from said brush head; and
a flow control device for controlling fluid flow between said reservoir and said at least one hole;
heating said grill;
filling said internal reservoir with a fluid; and
bringing said plurality of bristles into moving contact with the surface of the grill while the fluid is dispensed through the at least one hole.

47. The method of claim 48 wherein said flow control device comprises a flow restrictor for regulating the rate of fluid flow from said reservoir to said at least one hole.

48. The method of claim 47 wherein said flow restrictor comprises a conduit in fluid communication with said internal reservoir and said at least one hole.

49. The method of claim 47 wherein said conduit has a generally elliptical-shaped opening at an end closest said at least one hole.

50. The method of claim 49 wherein said brush head further comprises a second reservoir in fluid communication with said at least one hole and said opening.

51. The method of claim 50 wherein said opening is situated approximately over the center of the second reservoir.

52. The method of claim 48 wherein said conduit is oriented at a generally acute angle with respect to said brush head.

53. The method claim 46 wherein said flow control device comprises a shut off valve for regulating fluid communication between said reservoir and said at least one hole.

54. The method of claim 53 wherein said shut off valve has an open position which allows fluid communication between said reservoir and said at least one hole and a closed position which prevents fluid communication between said reservoir and said at least one hole.

55. The method of claim 54 further comprising the step of placing said shut off valve in the open position.

56. The method of claim 46 wherein said grill brush further comprises an in-take valve having one end in fluid communication with the ambient environment and one end in fluid communication with the internal reservoir.

57. The method of claim 56 wherein said intake valve further comprises a slit-shaped opening on said end in fluid communication with the internal reservoir.
